(19) United States
(12) Patent Application Publication
(10) Pub. No.: US 2013/0081206 A1
(43) Pub. Date: Apr. 4, 2013

(54) SURGICAL STRAP

(71) Applicant: Steven H. Ginsberg, Bridgewater, NJ (US)

(72) Inventor: Steven H. Ginsberg, Bridgewater, NJ (US)

(21) Appl. No.: 13/684,810

(22) Filed: Nov. 26, 2012

Related U.S. Application Data
(63) Continuation of application No. 12/613,909, filed on Nov. 6, 2009, now abandoned.
(60) Provisional application No. 61/198,623, filed on Nov. 6, 2008.

(51) Int. Cl. A61G 13/12

(52) U.S. Cl. CPC A61G 13/123; A61G 13/1235
USPC 5/623; 5/624

(57) ABSTRACT

The invention is directed to a strap that can be used to hold a patient's extremity to a board or operating table while at the same time provided a blanket-like surface between the patient and the operation table or board.

This application is a continuation of U.S. application Ser. No. 12/613,909 filed Nov. 6, 2009, which claims which claims benefit of priority to U.S. Provisional Application Ser. No. 61/198,623 filed Nov. 6, 2008, the contents of which are incorporated herein by reference in their entireties.

This invention relates to the discovery and development of a novel “strap” that is useful during surgery. Patients often need to be secured to the operating table or boards attached thereto during surgery to prevent injury.

During surgery, in order to keep patients skin clean and out of contact with operating room surfaces and be secured during their surgery, presently tape and gauze are used, especially in association with securing patient's extremities such as arms or legs. Some institutions use a reusable Hook and loop fastener strap which can get dirty or contaminated between surgeries. Presently a towel is often wrapped with tape, circumferentially around a patients arms. The towels often come from a sterile pack of operating room towels, a costly process when it just has to be clean and not sterile. This does not allow for a warming blanket to touch the patient's skin. The blankets warm best by touching skin. As such, the currently practiced methods to keep patients secured are multi-faceted and cumbersome with the possibility of contamination between surgeries. Therefore there remains a need for improved and more economical methods to keep patients secure during surgery.

### SUMMARY OF THE INVENTION

In one aspect, the invention is directed to a strap that can be used to hold a patient's extremity to a board or operating table while at the same time provided a fabric or material surface between the patient and the operation table or board.

In another aspect, the invention is directed to a strap that is cleaned after use.

In another aspect, the invention is directed to a strap that is disposed of after use.

### BRIEF DESCRIPTION OF THE DRAWINGS

FIG. 1 is a depiction of one side of a preferred embodiment of the strap of the invention.

FIG. 2 is a depiction of the other side of a preferred embodiment of the strap of the invention.

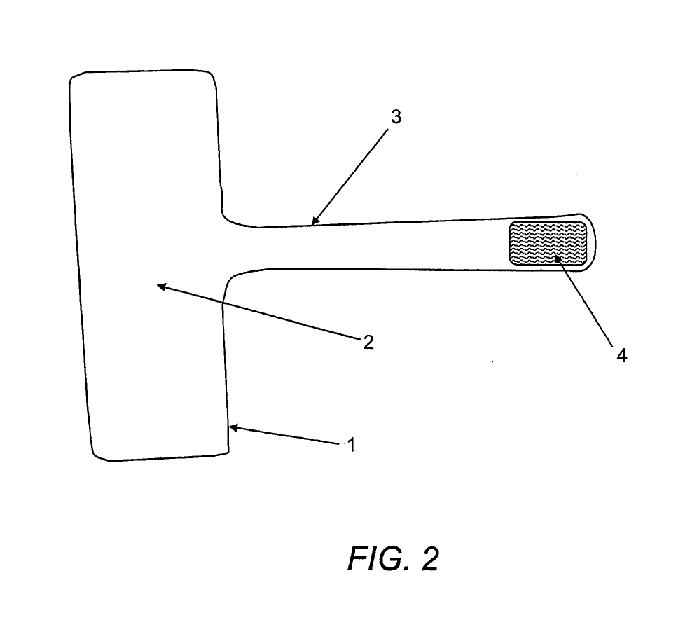

### DETAILED DESCRIPTION OF THE INVENTION

The novel straps of the invention provide
a) an interface used between a patient's skin and the vinyl of an operating room table or the operating table arm board or leg board;
b) a strap attached to One Side of the interface, wherein the strap is of sufficient length to wrap around the operating room table or the operating table arm board or leg board; and
c) a means to fasten the end of the strap so that a patient's extremity is secured to the operating room table or the operating table arm board or leg board.

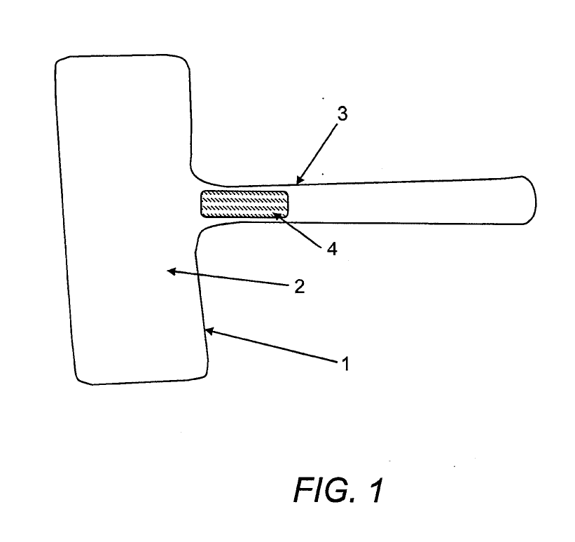

In one embodiment of the invention, as depicted in FIG. 1, the strap of the invention (1) is one piece which includes a piece of cloth or disposable material (2) that is attached to a strap (3) that has an adjustable fastening means, such as a buckle or hook and loop fastener (4).

The strap of the invention also has a dual function. The first is to be comfortably placed on a clean cloth or other material instead of on the vinyl type surface which presently exists on the operating room table or the operating table arm board or leg board. The second is to keep the patient in place on the operating table or the operating table arm or leg boards during surgery. It helps to limit cross contamination of patient's skin touching the vinyl operating table surface or operating table arm or leg boards which are re-used from surgery to surgery. This will also allow for an air warming blanket to touch the patient's skin. The blankets warm best by touching skin.

The novel straps described in this invention cover only a small width of the patient's extremity, for example from about 2 to about 5 inches which results in only a small portion of patient skin being covered by fabric. This enables greater coverage by a hot air warming blanket.

The straps of the invention can be disposable so that they are used on a single patient and then discarded or they are made of a material that can be washed and or sanitized before the next use. The portion of the strap under the patient or the patient's arms or legs could be made of a gel type of material to add cushioning and/or help prevent nerve injury. Alternatively, a readily available gel cushion could be inserted in a pocket in the portion of the strap under the patient.

In one embodiment of this invention patients need their arms secured to arm boards while they have surgery so that they don't come loose and suffer nerve injury.

In another embodiment, the patient's legs are secured.

In yet another embodiment of the invention a patient's torso may be secured to the operating table to prevent undesired movement during surgery.

These straps can also be useful for any application which might require the securing of one item to the other or holding an item in place. The fabric used might be part of a warming device or blanket which is commonly used during surgery to keep patients warm. This could be multi functional, i.e. barrier between skin and vinyl arm board, securing device, warming device and similar. The cloth portion of the strap could also have a pocket to hold a warming device or other apparatus.

The body of a patient is also secured with a strap to the operating room table. This fabricated strap might be used under a patient (a larger version) to be a strap around the patient during surgery. This can secure the patient to the operating room table. This can be used in place of the separate strap that is presently used. If it is used to secure a patient to the operating room table then it can be combined with the operating room table linen and made of a material which allows fluids to pass through and protect the patient (a diaper like material). This can isolate a patient from cold fluids (such as blood or irrigation); or it can be used as a warming device, such as part of an underpatient hot air warming blanket. Presently when cold fluids remain in contact with a patient they help to worsen hypothermia which leads to many physiological problems.

### Details of Straps:

One piece of cloth or non latex material would be used. The description to follow will be as if multiple pieces are used in order to better describe it.

For use with an arm board, a piece of fabric could be about 7 inches wide by about 27 inches in length. This piece lays over the surgical arm board. At about 12.5 inches there would be a piece of fabric which is about 2 inches wide miming perpendicular to the original 7×27 inch piece, It would be from one side of this fabric and be about 26 inches in length (2×26). The purpose of this 2×26 inch strip is to wrap circumferentially around a patients' arm in order to secure it to the operating room table, This 2×26 inch strip would have hook and loop fastener attached to it for parts of its length. On the one side it would have hook and loop fastener from about 2 inches to about 8 inches and on the other side it would have hook and loop fastener (of the opposite form to adhere to the first length of hook and loop fastener) from about 24 inches to about 33 inches of its length. Because of the location, either in the middle or off center, of the 2×26 inch strip in relationship to the 7×27 inch base piece of fabric it could be used for either arm (both arms) of a patient by just turning it around or by having specific right and left devices. Two of these would be needed for each surgery where the patient arms are out from their sides (this is for most surgery).

For other uses, the dimensions of the straps can be adjusted as necessary. It is contemplated within the invention that either the hook and loop fastener portion or the fabric portion or both can be adjusted.

Although the invention is illustrated and described herein with reference to specific embodiments, the invention is not intended to be limited to the details shown. Rather, various modifications may be made in the details with the scope and range of equivalents of the claims and without departing from the invention.

1. A surgical strap which comprises
a. an interface used between a patient's skin and the vinyl of an operating room table or the operating table arm board or leg board;
b. a strap attached to one side of the interface, wherein the strap is of sufficient length to wrap around the operating room table or the operating table arm board or leg board; and
c. a means to fasten the end of the strap so that a patient's extremity is secured to the operating room table or the operating table arm board or leg board.

2. The strap of claim 1 which is made of washable material.

3. The strap of claim 1 which is made of disposable material.
